(19) United States
(12) Patent Application Publication
(10) Pub. No.: US 2005/0162655 A1
(43) Pub. Date: Jul. 28, 2005

(54) Method and apparatus for monitoring trace constituents in a fluid

(76) Inventor: Shachar Nadler, Bolton (CA)

Correspondence Address: BERESKIN AND PARR, 40 KING STREET WEST, BOX 401, TORONTO, ON, M5H 3Y2, CA

(21) Appl. No.: 11/081,533

(22) Filed: Mar. 17, 2005

Related U.S. Application Data
(63) Continuation of application No. 09/664,705, filed on Sep. 19, 2000, now abandoned.
Application No. 09/664,705 is a continuation of application No. 08/508,505, filed on Jul. 28, 1995, now abandoned.

(51) Int. Cl. G01N 21/00

(52) U.S. Cl. 356/437

(57) ABSTRACT

An apparatus for remote detection of selected trace constituents in a fluid, for example flue gases from a stack, has a laser for generating a laser beam. The laser beam is transmitted through the fluid and the returned laser beam is detected after transmission through the fluid. A detector receives the returned laser beam, to detect the presence of any of the selected trace constituents, by comparison of the transmitted and returned beams. An optical fiber connection means, which can comprise either a single optical fiber or a pair of optical fibers, provides a connection between at least one of (i) the laser and a transmitter for the laser beam, and (ii) a receiver for the laser beam and the detector. This enables the detector and the laser to be located remotely and away from hostile environments.

### CROSS-REFERENCE TO RELATED APPLICATION

This application is a continuation of application Ser. No. 09/664,705 filed Sep. 19, 2000 which is a continuation of application Ser. No. 08/508,505 filed Jul. 28, 1995, now abandoned, the entirety of which are hereby incorporated by reference.

### FIELD OF THE INVENTION

This invention relates to a method and apparatus for monitoring and measuring trace constituents in a fluid, and more particularly relates to monitoring and measuring trace constituent gases in the atmosphere. It is particularly concerned with apparatus suitable for remote sensing and monitoring of such constituents.

### BACKGROUND OF THE INVENTION

Pollution is of ever increasing concern. One type of pollution that is of particular concern is atmospheric pollution by various gases. Consequently, it is becoming desirable to monitor gases, such as stack gases, emitted by industrial plants. This enables air quality to be monitored and emission standards to be met. It can also be a valuable process control tool, since variations in stack gases can be indicative of changes in process conditions and possible inefficiencies in the plant being monitored.

Various proposals have been made for monitoring stack gases, but most of them suffer from a number of deficiencies. For example, in U.S. Pat. No. 3,517,190, there is a relatively old proposal for monitoring a smoke plume from a stack. It is illuminated with radiation of a broad spectral range. A remotely positioned receiver, in proximity to the source receives scattered radiation. A processing technique is used to develop signals from the scattered radiation and to analyze these signals to measure the quantity of an absorbing gas of interest in the plume. Here, both the source and the detector are located remotely from the plume, and must be accurately aligned to illuminate the plume and receive the radiation reflected back. The patent notes that various conditions need to be met for the method to be accurate, including scattering and absorption agents being uniformly distributed throughout the plume section. The scattering co-efficient over the spectral interval needs to be considered constant or its variation needs to be predictable, and the stack plume must be optically thin, i.e. the radiation scatter must be small compared to incident radiation. It notes a problem that might arise by scattering of radiation from clouds in the background.

A solution to some of these problems is to mount both the source and a detector close to the top of a stack. However, this is usually an extremely hostile environment, where instruments are subject to extreme weather conditions and gases emitted by the stack. Since the source and the detector are relatively sensitive instruments, this can cause problems, and it is not easy to access the instruments for repair and maintenance.

U.S. Pat. No. 3,838,925 shows a photoelectric opacity measuring system that is mounted on a smoke stack. It suggests the use of a conventional lamp for illumination. A further installation on a stack is disclosed in the Ryan U.S. Pat. No. 4,652,756.

More recent proposals do suggest the use of a laser light source, such as in U.S. Pat. No. 5,343,043 (Johnson). This discloses a remote sensor device for monitoring motor vehicle exhaust systems, and is intended to provide high speed sampling. The laser is provided immediately adjacent to the intended path, but there is no discussion of remotely mounting the laser. Given the intended application, remote mounting of the laser would give no significant advantage or benefit.

A more recent U.S. Pat. No. 5,373,160 is concerned with detection of remote hazardous air pollutants. It directs a laser beam of infrared light along a sight path, to illuminate the gases. A telescope is directed along the sight path and collects light from the gases. An optical filter is coupled to the telescope for selecting a particular optical wavelength or band, and focusing a filtered wavelength on the detector. The invention is intended to provide a long path infrared spectrometer arrangement, and mentions a path length of up to 6 km. As such, the laser would apparently be mounted some distance from a plume from a stack. As noted above, this could lead to various problems in obtaining an accurate reading.

Current and upcoming regulations involve measuring emissions from industrial stacks. Examples of the emission gases that require monitoring include CO₂, CO, NO_{X} and SO₂ in fossil-fuel combustion processes, NH₃ slippage in ammonium-denox power utilities, HF in aluminium and ceramic production, H₂S and reduced sulphur in pulp and paper plants, CH₄ in natural gas pumping stations, HCl in incinerators, etc.

Standard methods have been developed for extracting samples of stack gas for subsequent analysis in the laboratory. Such methods have dropped from favour because of questions of representativeness of these samples. They have now largely been replaced by continuous extractive methods where the stack gases are continuously sampled from the stack to instruments, located outside the stack, usually separate instruments for each of the stack gases being monitored. Such extractive methods are very complex and cumbersome, requiring heating along the sample lines and elaborate calibration techniques. They also require the cumbersome extractive probe, associated sampling lines and instruments to be located at the stack level, with the resulting exposure to varying weather conditions. They also require maintenance of the instrumentation at locations which are difficult and inconvenient to access. Nevertheless, these extractive methods are the basis of most EPA (Environmental Protection Agency) approved methods in the U.S.A.

The difficulties and inconveniences of these extractive methods have given rise to the development of optical methods of continuous in-situ monitoring of stack gases by transmitting a light beam of appropriate wavelength across all, or part of, the stack, and measuring the optical absorption. Both infrared and ultraviolet wavelengths have been used for this procedure. The advantages over extractive methods include the elimination of the heated sampling probes. One disadvantage of these remote-sensing optical methods is that the light sources that have been used to date are broad-band, which can result in interferences between the individual gases in the stack gas mixture. For example, in power plant utilities using NH₃-denox procedures it is impossible to distinguish SO₂ from NH₃ using the existing ultraviolet instruments. Similarly, the use of fourier-transform infrared (FTIR) techniques encounters large interferences from CO₂ and H₂O. In addition, regulatory agencies, such as the US EPA, have demanded that calibration of such instruments must be performed in the stack under conditions of the same pressure and temperature as the stack gases since it is known that optical absorption is dependent on both temperature and pressure. Also, separate instruments are still required at each stack location in a multiple stack industrial site.

Although existing optical methods do eliminate the need for heated sampling lines, they still require the presence of the optical instrument at the stack location with the aforementioned difficulties of exposure to inclement weather and large temperature variations and with the difficulties in accessing the instruments for servicing.

### SUMMARY OF THE PRESENT INVENTION

In accordance with the present invention, there is provided an apparatus for remote detection of selected trace constituents in a fluid, for example in flue gases. The apparatus comprises:
a laser for generating a laser beam;
an optical transmission means, for transmitting the laser beam through a fluid, and connected to the laser;
receiving means for receiving a returned laser beam after transmission through the fluid;
a detector means for analyzing the returned laser beam for detecting the presence of any of the selected trace constituents by comparison of the transmitted and returned beams; and
an optical fiber connection means providing a connection between (i) the laser and the optical transmission means, and (ii) the receiving means and the detector means.

In one use of the apparatus of this invention the optical transmission means and the receiving means are mounted to a stack that discharges flue gases to the atmosphere. In particular, the transmission means and receiving means are mounted adjacent the top of the stack on opposite sides of the stack, whereby the laser beam is transmitted through the flue gases discharged from the stack. The laser and detector means are then located in the enclosed area of the building, so as to be protected by that enclosed area. The transmission means and the receiving means are located remote from the laser and the detection means and are connected to them by the optical fiber connection means.

Preferably, the optical fiber connection means provides a connection between both the laser and the optical transmission means, and between the receiving means and the detector means. Advantageously, the optical fiber connection means then comprises a first optical fiber connecting the laser to the optical transmission means, and connecting the receiving means to the detector means for transmission of a returned beam. Alternatively, two optical fibers may be provided.

It has been found that a single mode fiber can be used and that the returned beam can be readily focused on the end of the optical fiber, despite its small diameter, so that the single fiber can be used for both transmission and reception. Also, despite the requirement to provide splitter and combiner means at the laser, high efficiencies can be achieved.

The apparatus can include a beam splitter and combiner means connected between the laser and the optical fiber, the beam splitter and combiner means also being connected to the detector means. A reference cell can then be provided, connected to the beam splitter and combiner means for receiving part of the radiation from the laser, for reference purposes.

Advantageously, the apparatus includes a multiplexer means and a plurality of pairs of transmission and receiving means, the multiplexer means providing a connection between the optical fiber and the pairs of transmission and receiving means, for selective connection to one pair thereof. A multiplexer means can also be provided between a plurality of laser sources and the optical fiber, in addition to or instead of splitter and combiner means, to enable a number of different frequencies to be transmitted through the gas or fluid. Where two optical fibers are required, then two multiplexers would be provided.

The transmission and reception means can be provided in various ways. The transmission means and the receiving means can comprise a single unit providing for coaxial transmission and reception, the apparatus further including a retroreflector for reflection of the laser beam transmitted from the transmission means back to the receiving means. In another embodiment, the receiving means is separate from the optical transmission means, for mounting on either side of an area through which a gas or fluid to be analyzed passes, and in this case two optical fibers would be required. In a further embodiment, the transmission means and the receiving means comprise a point source monitor, including a multipass sample cell, providing an extended analytical path. In a fourth embodiment, the transmission means and the receiving means are provided in a stack probe, for monitoring a flow including dust particles, the probe including means for maintaining optical transmission surfaces free of dust particles.

A control unit can be provided that modulates the laser beam, which preferably is an infrared beam generated by a diode laser. The control unit then includes a two tone generator for generating two frequencies that modulate the laser beam. The detector detects a return signal which is the difference in those two frequencies and is connected to the control unit and the control unit further includes filtering means for filtering out the return signal and a mixer for comparing the return signal to a signal representative of the transmitted signal, to generate a difference signal indicative of the detected concentration of the selected constituents.

### BRIEF DESCRIPTION OF THE DRAWING FIGURES

For a better understanding of the present invention and to show more clearly how it may be carried into effect, reference will now be made, by way of example, to the accompanying drawings, which show a preferred embodiment of the present invention and in which:

FIG. 1a is a schematic view of an apparatus in accordance with one embodiment of the present invention;

FIG. 1b is a schematic view of an apparatus in accordance with a second, preferred embodiment of the present invention;

FIG. 2 is a schematic of the controller of the apparatus of the present invention;

FIG. 3a is a schematic view of fiber optic connections of the first embodiment of the apparatus of the present invention;

FIG. 3b is a schematic view of fiber optic connections of the second embodiment of the apparatus of the present invention;

FIG. 4a is a schematic view of fiber optic connections showing the use of multiple lasers in a first embodiment of the invention;

FIG. 4b is a schematic view of fiber optic connections showing the use of multiple lasers in a second embodiment of the invention;

FIG. 5a is a detailed schematic view of the optical configuration for a remote sensing configuration of the first embodiment;

FIG. 5b is a detailed schematic view of the optical configuration for a remote sensing configuration of the second embodiment;

FIG. 6 is a detailed schematic view of the optical configuration showing a point source monitor of the apparatus of the present invention;

FIG. 7 is a schematic view showing the use of multiple targets for grid monitoring; and

FIG. 8 is a schematic view of an application of the present invention to remote monitoring of stack gases.

### DESCRIPTION OF PREFERRED EMBODIMENT

Two embodiments of the invention are described, the first being based on the use of separate optical fibers for the transmitted and returned signals and the second relying on a single fiber for both transmission and reception. The single fiber technique is preferred for the reasons given below, although for some applications two fibers are required.

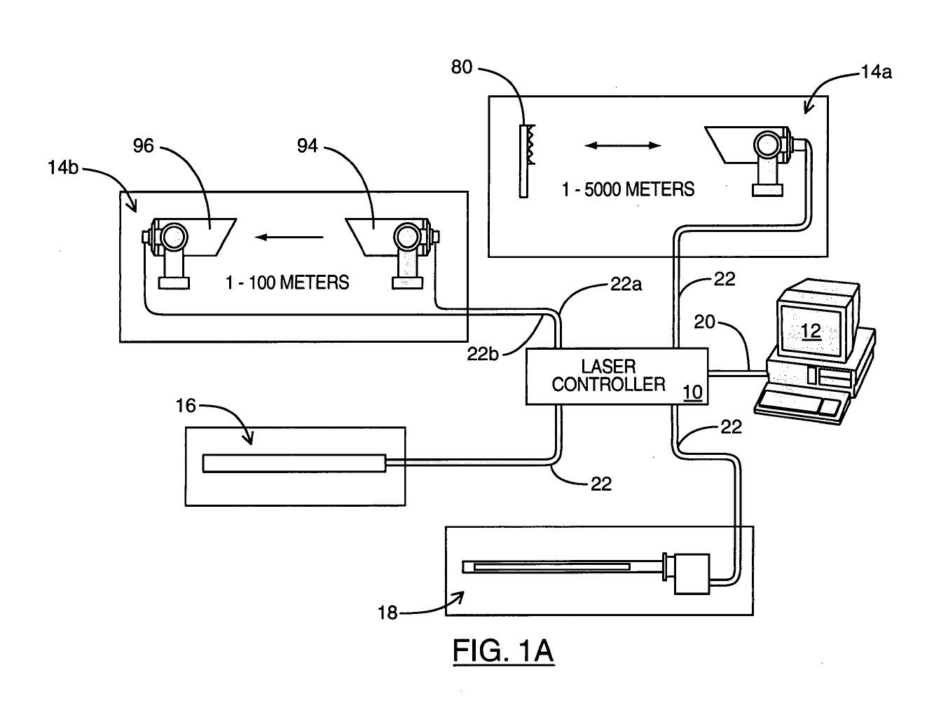

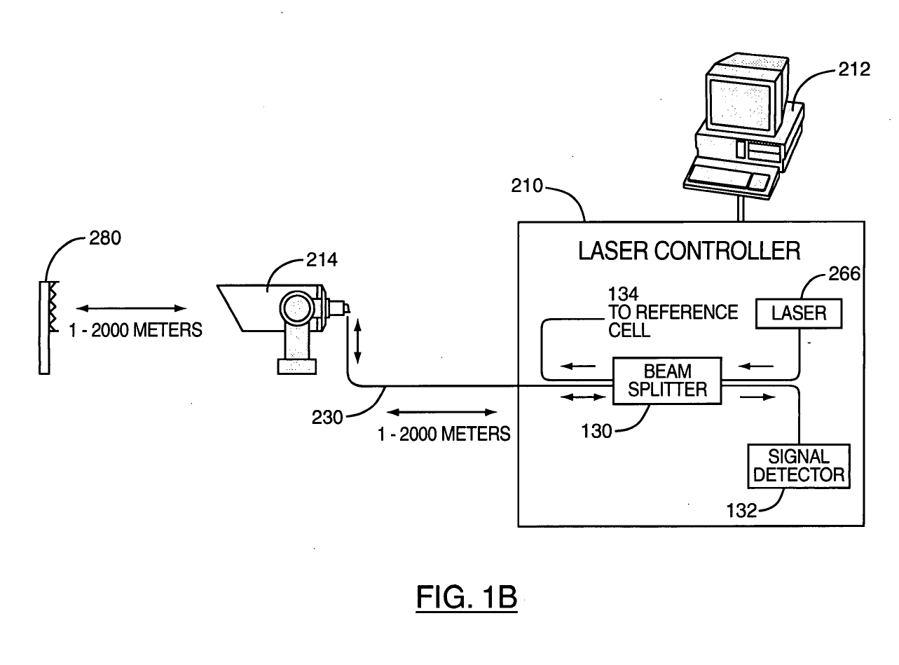

Referring first to FIG. 1a, this shows an overall schematic view of the first embodiment of the present invention, and indicates how three, basic, different systems can be configured. The system or apparatus is essentially modular and can be assembled in a variety of configurations, as desired. Thus, in FIG. 1a, a laser controller 10 is connected to a control and data acquisition computer 12. The laser controller 10 can be connected to different remote sensing instruments 14, indicated in two different configurations at 14a and 14b. It can also be connected to either a point source monitor 16 or a stack/probe monitor 18. The controller 10 includes the laser and a suitable detector for the returned signal, although not shown in FIG. 1a.

The laser controller 10 is linked by both electronic cables and fiber optic cables to other elements of the apparatus. Electronically, the components are coupled by a 50 ohm coaxial cable, as indicated at 20, connecting the controller 10 to the computer 12. Optically, the laser controller 10 is connected to the different devices by pairs of fiber optic cables 22, each comprising a single mode fiber 22a carrying the transmitted laser light to a transmitter and a multimode fiber 22b, carrying the return or received light. Optical coupling offers several advantages. It facilitates operations in adverse and hazardous (combustible) environments. In addition, the very low gain loss permits the laser and laser controller 10 to be located several hundred metres away from the site at which the actual measurement takes place.

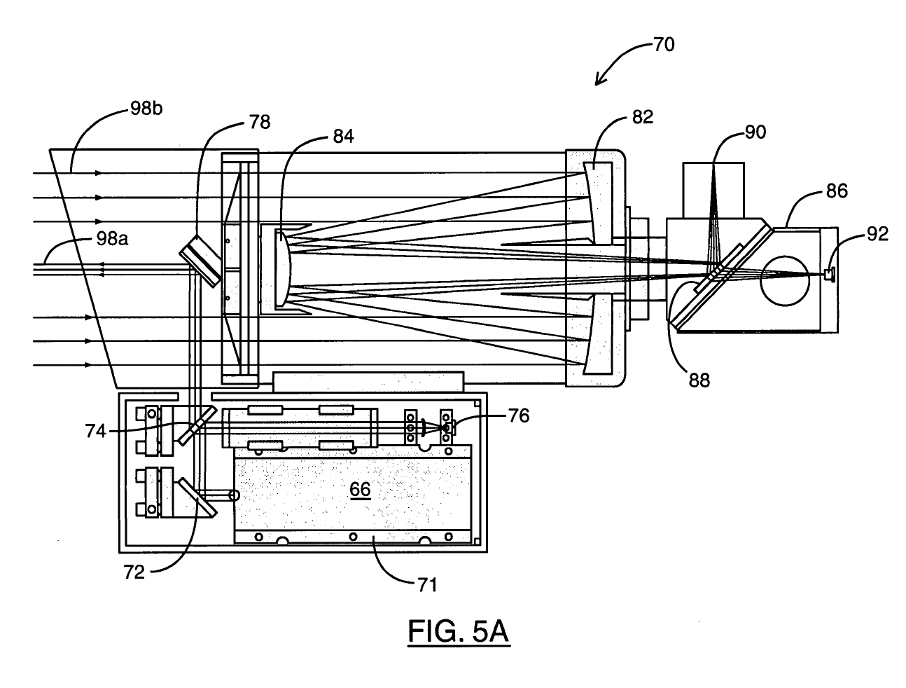

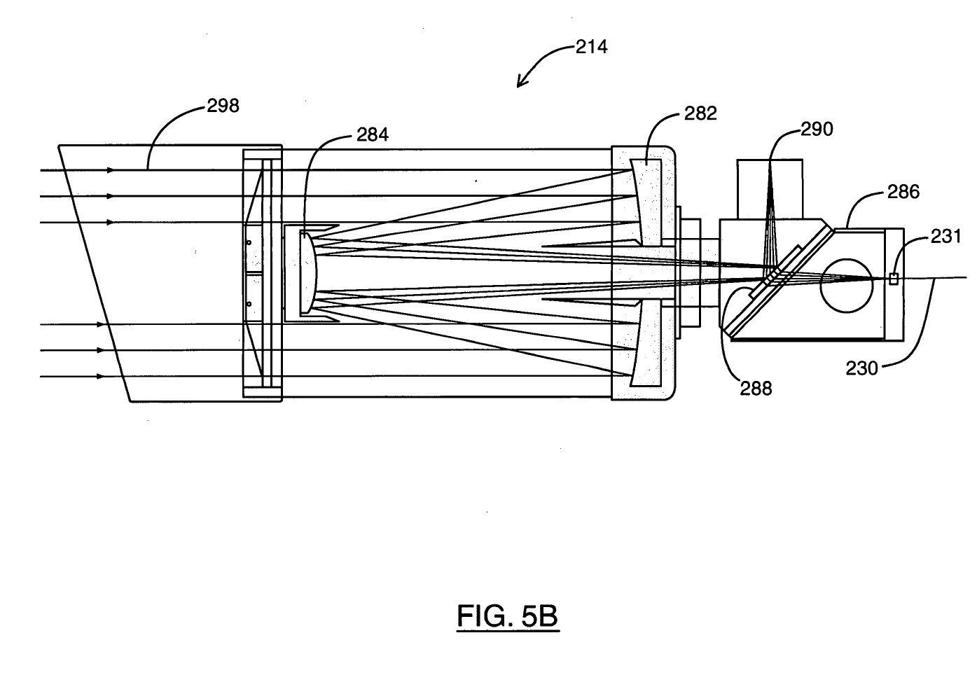

Reference will now be made to FIG. 5a, which shows details of a transmitter telescope 70 suitable for the configuration 14a, but with the laser and detector located on the telescope. The connection to the telescope would then be by way of conventional cables and not by optical fibers.

In FIG. 5a, the laser 66 is mounted by a laser mount 71 and its output is reflected off a folding flat mirror 72. A beam splitter mirror 74 splits off a small portion, approximately 10 percent of a laser beam, to a secondary detector or reference cell 76. The telescope 70 may be either refractive, reflective or a combination of both. The telescope aperture is given or set by the range of analytical path required; a 10 cm. aperture is required for a 10-500 meter base path a 20 cm. aperture is required for 500-2,000 meter path.

The main output from the laser continues to a transmission or steering mirror 78. This reflects the output to form a beam 98a travelling to a retroreflector 80 (FIG. 1a), which provides a cubic array in known manner, to reflect the beam back along the same path on which it was received. Consequently, the analytical path is twice the base path distance. The returned beam 98b is received by a concave mirror 82, which focuses the beam down to a secondary mirror 84. This mirror 84, in turn, focuses the beam into a main detection cell 86. Within the cell 86, a beam splitter 88 divides the beam into a small portion directed to an eye piece or automatic alignment mechanism 90, and a main portion that passes through to a primary detector 92.

It will be appreciated that the telescope could readily be modified for connection to a remote laser and detector, by removing the laser and the detector and providing appropriate connections for the two optical fibers 22a, 22b.

The second preferred embodiment of the present invention utilizes a single mode fiber but otherwise is similar in many respects to the first embodiment. For simplicity and brevity, similar reference numerals used for the first embodiment are used for the second embodiment, but starting at 200, so that the laser controller 10 becomes laser controller 210, computer 12 becomes computer 212, etc. For brevity, descriptions of common elements are not repeated and the description of the first embodiment is equally applicable.

Referring to FIG. 1b, the laser controller 210 includes a beam splitter and combiner 130 having a connection to the laser 266. A signal detector 132 is connected to the beam splitter 130 for receiving a returned beam, while a reference cell 134 is also connected to the beam splitter and combiner 130 for receiving a portion of the original laser beam from the laser 266 for reference.

The remote sensing instrument or telescope 214 is similar to the configuration 14a of the first embodiment. However, just one optical fiber 230 is provided, which is a single mode optical fiber, which is connected between the beam splitter and combiner 130 and the telescope or instrument 214. As before, a retroreflector 280 is provided.

It will be appreciated that, as shown in FIG. 1b, the beam splitter and combiner 130 diverts half of the radiation from the laser to the reference cell 134. Correspondingly, the effect of the beam splitter 130 is to cause only half of 50% of the return radiation to reach the signal detector 132; the other half is transmitted to the laser 266, and an optical-isolator is provided that protects the laser from the interfering effects of this radiation. Accordingly, the overall efficiency is only 25%.

However, as compared to the two fiber system of FIG. 1a, this is an improvement. Due to the inefficiencies in collecting the returned radiation, typically only 15% efficiency is achieved for the two fiber system. Thus, despite the extra inefficiencies built in by the beam splitter 130, the overall efficiency is in fact greater with a single fiber.

FIG. 5b shows details of the optical configuration of the instrument 214. The optical fiber 230 terminates at termination end 231 in a connection unit 286. The unit 286 provides an eye piece 290 and an input/output connection. It includes a beam splitter 288 for diverting a portion of the returned beam to the eye piece 290 for alignment with the retroreflector 280. As before, the telescope assembly includes a concave mirror 282 and a secondary mirror 284.

Unlike the first embodiment of FIG. 5a, the laser 66 and related components are omitted, since the laser 66 is provided remotely as laser 266 in the control unit. Instead, the beam is received through the single mode fiber 230 and focused by the mirrors 284/282. The retroreflector 280 by its inherent design returns the beam along exactly the same path. The mirrors 282, 284 ensure that the beam 298 returns along the same path and is focused on the end of the optical fiber 230. Thus, even though a single mode optical fiber 230 has a small cross-section of approximately 10 microns, efficient collection of a returned beam can be obtained, and indeed virtually all the returned beam can be collected and returned back down the optical fiber 230. Even if the end 231 of the optical fiber 230 is slightly misaligned, the optical arrangement is such that the return beam will always exactly traverse the path of the outgoing beam, so such misalignment has no effect.

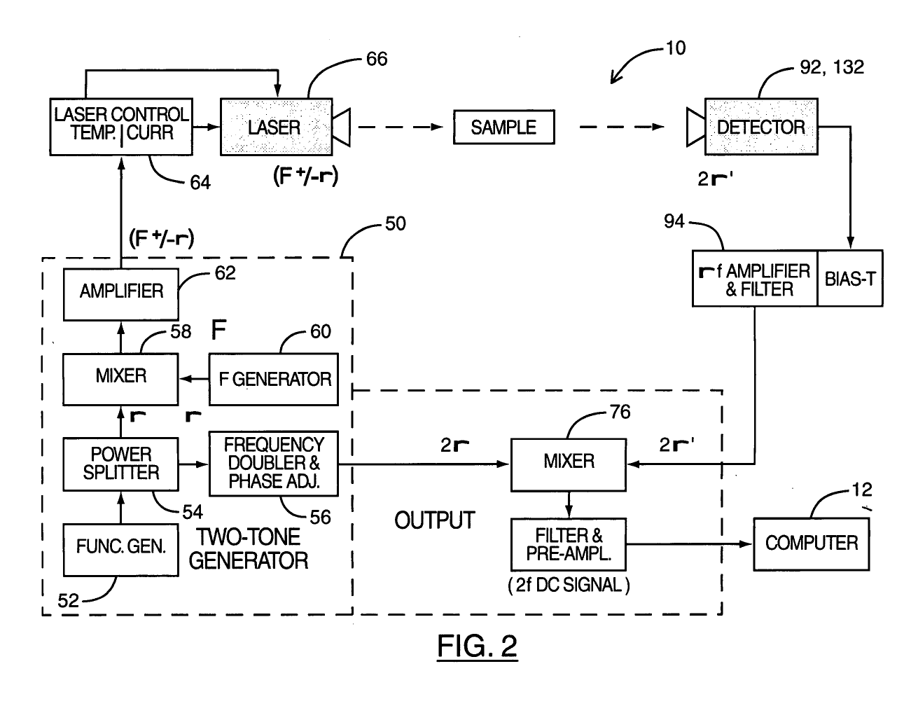

Reference will now be made to FIG. 2 which shows details of the laser controller 10 of the first embodiment; this controller is also applicable to the second embodiment, described below. The controller 10 includes a two tone generator 50. This two tone generator includes a function generator 52 connected to a power splitter 54. The function generator 52 generates a frequency “r”. Part of the signal is split off to a frequency doubler and phase adjuster unit 56, where the frequency is doubled to “2r”.

The main portion of the signal is fed to a mixer 58, which also has an input connected to a generator 60. The generator 60 generates a frequency “F”. The mixer 58 mixes the two signals to create two signals F+r and F−r. These two signals are amplified in an amplifier 62 and then connected to a laser control unit 64. The laser controller includes the control unit 64 and the actual laser, indicated at 66, controlled by the control unit 64. The laser 66 is a near infrared (NIR) diode laser. The laser control unit 64 provides a thermoelectrically cooled unit for temperature control, for coarse control. Laser emission is obtained by injecting an appropriate current across the diode supplied by a stabilized current source. The laser control unit 64 also provides a ramp generator with a frequency in the range 10-100 kHz to fine tune the emission wavelengths rapidly across the absorption range of interest. A stable repetitive scan facilitates multi scan averaging which in turn improves the sensitivity of the system. The additional frequencies supplied by the two tone generator 50 augment the basic sensitivity of the system. The two tone frequency modulation facilitates data extraction from the FM bands generated. The two signals F+r and F−r are superimposed on the laser driver current by means of a bias T.

FIG. 2 indicates a detector at 92, 132 to indicate that the detector could either be mounted on the telescope as in FIG. 5a or remotely as in FIG. 1b. The signals received by the detector 92, 132 are band filtered and demodulated in a filter unit 94, which also allows for the bias T. The filtered signal 2r′ is fed to a mixer 96, which also receives the original signal 2r from the frequency doubler 56. If the detected signal 2r′ is the equivalent to the signal 2r fed to the mixer 96 and representative of the original signal, then the difference between the two signals will be 0 and the DC output will be 0. Where an absorption feature distorts the measured signal 2r′, then there will be a difference, and a DC output will be provided, which is proportional to the detected difference. The DC output from the mixer 96 is low passed filtered and fed to an analogue digital converter interfaced with the PC based micro computer 12, for averaging, processing, comparison and temperature display.

For fixed frequency amplitudes, the measured DC voltage at the mixer 96 is directly proportional to the concentration of the absorbing gas.

A single laser controller 10 may hold and control several lasers and by means of a beam splitter light can feed light to single or several probes simultaneously. As the controller 10 is linked to a computer, the computer, in addition to manipulating and storing data, can also electronically control the operation of the controller 10.

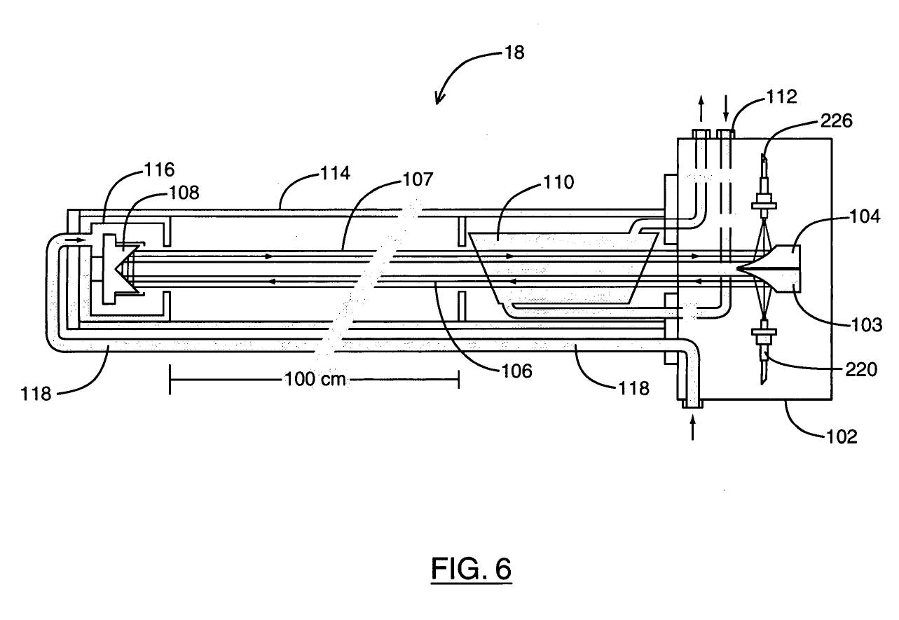

Referring now to FIG. 6, this shows a remote sensing probe or instrument 18, suitable for continuous, non-extractive stack and/or duct monitoring. This has a base 102, in which a pair of off-axis parabolic mirrors 103, 104 are mounted. The single mode cable 22a from the laser provides a point source of radiation that is focused by the mirror 103 to a beam 106. A cubic retroreflector 108 reflects this beam back as indicated at 107. The beam 107 is reflected by the second parabolic mirror 104 on to the end of the multimode fiber 22b.

A calibration cell 110 is located to include the outward and return beam paths 106, 107. At 112, an inlet and an outlet are provided for calibration gas, for the calibration cell 110.

The main working section of the stack probe 100 is indicated at 114. It is suitably perforated to permit gas of interest to pass through it. The working section 114 has a length of 100 cm., to give an effective, analytical path of 200 cm.

The retroreflector 108 is enclosed in an end housing 116 connected to a gas supply duct 118. A supply of clean, cool gas is provided through the duct 118, to maintain the retroreflector 108 cool and clean. This can also be connected adjacent the cell 110, to ensure that it remains clean. The flow is such as to provide the necessary cleaning effect, without significantly disrupting flow of the gas of interest through the working section 114.

While FIG. 6 shows separate connections for the input beam and the return beam, with associated off-axis parabolic mirrors 103, 104, this is not essential. It can be configured for use with the second embodiment of the invention, where a single optical fiber is provided. In this case, a single input connection can be provided similar to that shown in FIG. 5b, and the mirrors 103, 104 omitted. A focus arrangement can be provided, and the retroreflector 108 configured to ensure that the return beam retraces exactly the outgoing beam. This again should ensure that the return beam is focused on to the end of the optical fiber.

The point source monitor 16 uses a light folding multi path analytical cell. The optical path in the cell may be adjusted to accommodate sensitivity requirements. Low volume multipath cells with a fixed optical path length of 12.5 and 50.4 metres are presently used by the applicant, but other configurations can be developed for other applications. Path lengths of up to 100 metres can be provided.

The overall system is a high resolution spectrometer that can detect and measure a large range of trace gases and ambient air. It can monitor one or several gases simultaneously, and as such is a powerful tool suitable for applications in air quality control, emission control and industrial process control.

The remote sensing configuration of FIG. 1a or 1b is suitable for measuring pollutant trace gases in ambient air. In an open environment, it can be installed on roof tops, and used as a monitor to record trends in air quality. It can also be used indoors. For large factory settings, the remote sensing configuration can be installed immediately below the ceilings of the manufacturing facilities. For smaller structures, the point source monitor 16 can be used for individual rooms or at an air circulation facility.

The system can be used for self-policing and as a potential standard for a regulatory market.

The configuration 14a or 214 can also be installed across a road for monitoring a car, and exhaust plumes in passing traffic. This system can be combined with an automatic camera, so as to record and identify vehicles whose exhausts offend set regulatory limits.

The stack monitor probe 18 and the point source monitor 16 can be installed on a stack to monitor industrial exhausts and flue gases. The point source monitor 16 can monitor potential pollution “hot spots”.

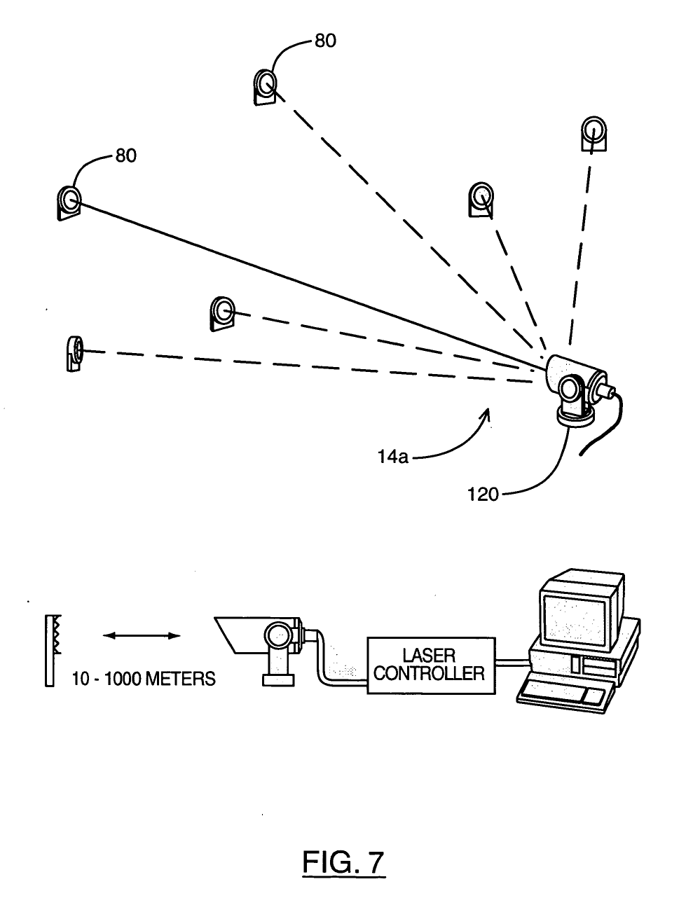

Referring to FIG. 7, the remote sensing instrument 14a can be installed on a mechanized mount, indicated at 120. It can then be provided with a plurality of reflectors 80. The mount 120 can than be used to focus the beam on each reflector 80 in turn. This provides a multi-target setting, which is ideal for fence and grid monitoring. This allows the user to map the behaviour of an area of interest and helps identify “hot spots”. Fence and grid monitoring are suitable for landfill sites and factory settings.

Practically all of the trace gases in industrial exhaust are due to chemical reactions, the system of the present invention can be used for process control feedback. Fluctuations in the concentration of some effluent gases and/or the appearance of new or unwanted components are often an indication of reaction efficiencies or reactions which are not proceeding ideally. Feedback from such information can be used to control the reaction, to maintain it at an efficient level and/or to prevent the production of pollutants or at least keep pollutant levels within regulatory limits. This can lead to more profitable operation of a plant, while reducing pollution levels.

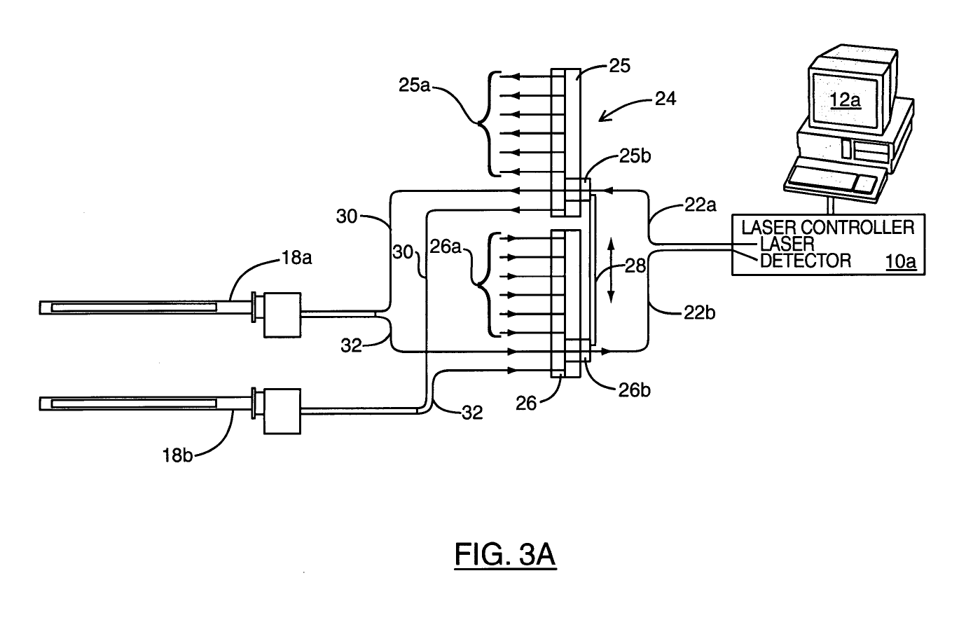

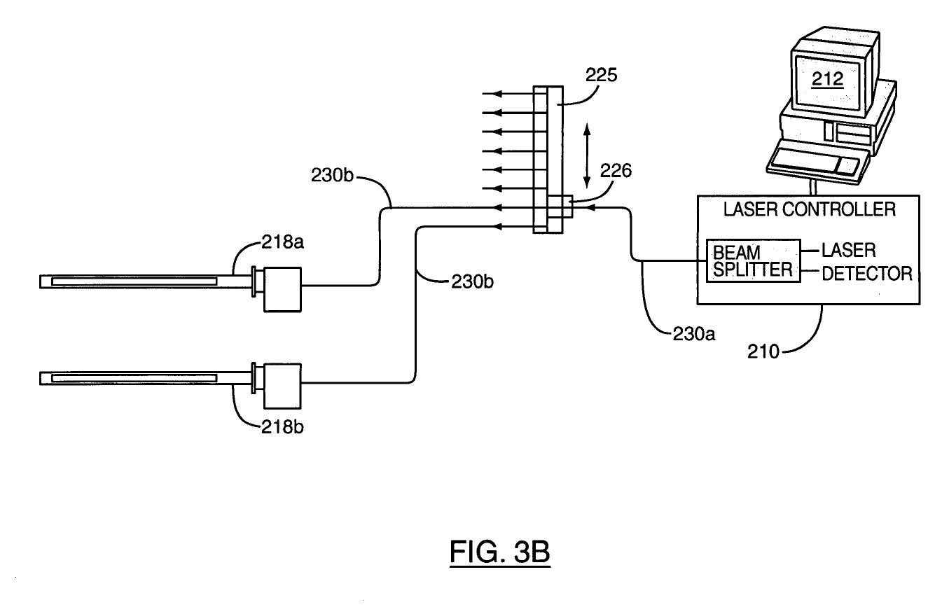

Referring to FIG. 3a, this shows a multiplexing arrangement. For exemplary purposes, this shows two stack probe monitors indicated at 18a and 18b, and a laser controller, here indicated at 10a connected to a controlling computer 12a (the suffix ‘a’ being used to distinguish from the earlier Figures).

Now, in accordance with the present invention, an optical multiplexer is provided at 24. This multiplexer 24 comprises first and second multiplexers 25 and 26, ganged together. Thus, the optical multiplexer 25 has a plurality of connections 25a on one side and a single connector 25b on the other side. The connector 25b is mounted for sliding movement, to permit its alignment with a selected one of the connections 25a. Correspondingly, the multiplexer 26 has a plurality of connections 26a on one side and a single connector 26b on the other side. The connection 26b is again mounted for sliding movement.

A connection bar 28 connects the two single connectors 25b, 26b, to form a switching mechanism.

Just one single mode fiber 22a connects a laser to the multiplexer 25 and correspondingly a single multimode fiber 22b connects the multiplexer 26 to a laser detector at the controller 10a.

On the other side of the multiplexers, there are a plurality of single mode fibers 30 connecting the connections 25a to appropriate devices, such as the probes 18a and 18b. Correspondingly, there are a plurality of multimode fibers 32 for communicating the returned light to the connections 26a of the multiplexer 26. Thus, a selected one of the probes connected to the multiplexers can be connected to the laser controller 10a.

It will be appreciated that the multiplexers 25, 26 can be reversed for selectively connecting one of a number of lasers to a single probe, for example, on a time sharing basis. This would enable monitoring of different species at different times. Alternatively, additional multiplexes can be provided connected to the connections 25b, 26b and a plurality of lasers connected to inputs of the additional multiplexers. Then, a selected laser can be connected to a selected sensing unit.

Referring to FIG. 3b, this shows a multiplexing arrangement for a single fiber configuration. This is shown in association with stack probes or monitors 218a and 218b. A single multiplexer 225 is provided connected by a single mode optical fiber 230 to the laser controller 210. The optical fiber 230 comprises a first portion 230a providing a connection to the multiplexer 225 and second portions 230b connecting the outputs 225 to the probes 218a and 218b. The multiplexer 225 has an input connector 226 that can be moved to a selected one of its outputs. As shown, the multiplexer provides a connection to the probe 218a with the probe 218b being inactive. The laser controller 210 can be as described above.

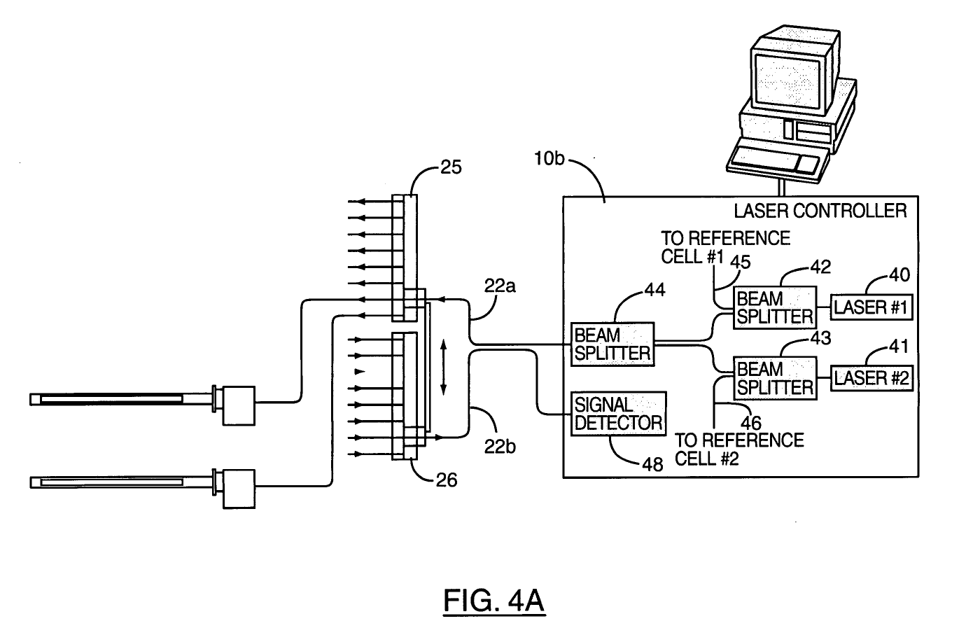

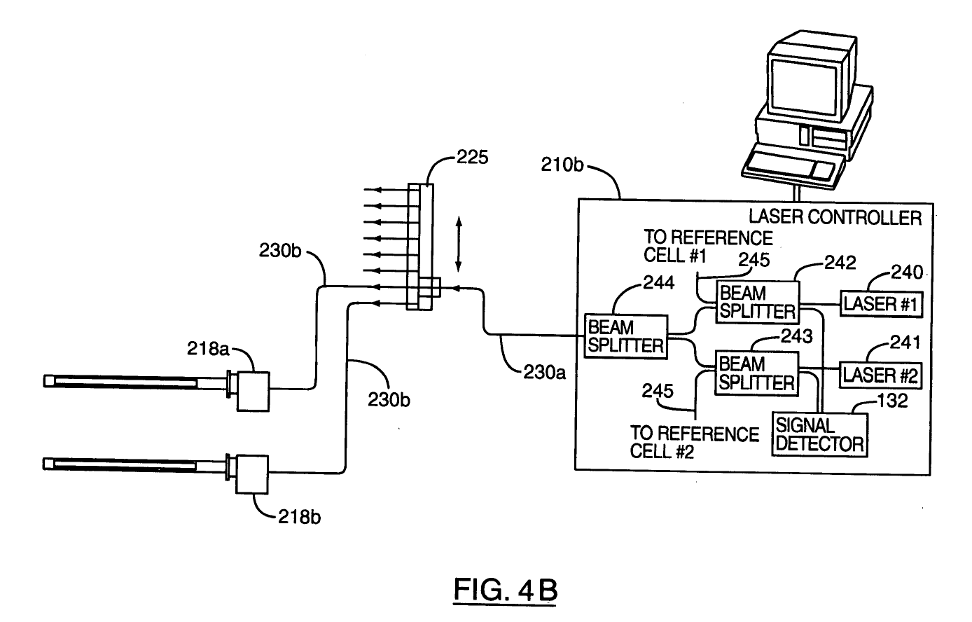

Reference will now be made to FIG. 4a, which shows the incorporation of beam splitters and combiners, which can be used instead of multiplexers for plural laser sources. Here, the multiplexers are also shown and similar components are given the same reference numerals as in FIG. 3a. To distinguish from earlier figures, the laser controller is here identified by the reference 10b.

The laser controller 10b includes at least two lasers 40, 41, connected through respective beam splitters 42 and 43. A fiber optic beam splitter is a device that splits the incoming light equally between two output fibers, so that each receives 50% of the input light.

Here, as shown, the outputs of the two beam splitters 42, 43 are connected to a beam splitter or combiner 44 that serves to combine the two half signals from the two lasers 40, 41. The other outputs from the beam splitters 42, 43 are connected to reference cells, as indicated at 45 and 46.

As before, a single mode fiber 22a provides a connection to the multiplexer 25, and a multimode fiber 22b provides a connection back from the multiplexer 26 to a signal detector indicated at 48.

Referring now to FIG. 4b, this shows an arrangement similar to FIG. 4a, but again in accordance with the second preferred embodiment with just one, single mode optical fiber 230, again shown as a first portion 230a and second portion 230b. Stack probes 218a and 218b are shown as in FIG. 3b. Here just the single multiplexer 225 is required.

The laser controller, indicated at 210b includes beam splitters 242, 243 and 244. A pair of lasers 240 and 241 are connected to the beam splitters and combiners 242, 243. The beam splitters and combiners 242, 243 are connected to a signal detector 132 and to reference cells indicated at 245.

This arrangement enables either one of the lasers 240, 241 to be connected to a selected one of the sensing instruments connected to the outputs of the multiplexer 225, here the probe to 218a. Instead of the beam splitter 244, if it is required to use a large number of lasers, another multiplexer can be used, configured to selectively connect one laser source to the optical fiber 230a.

The arrangements of FIGS. 4a and 4b enables a number of different frequencies to be transmitted to a single probe simultaneously, for simultaneous detection of different gases and components of interest.

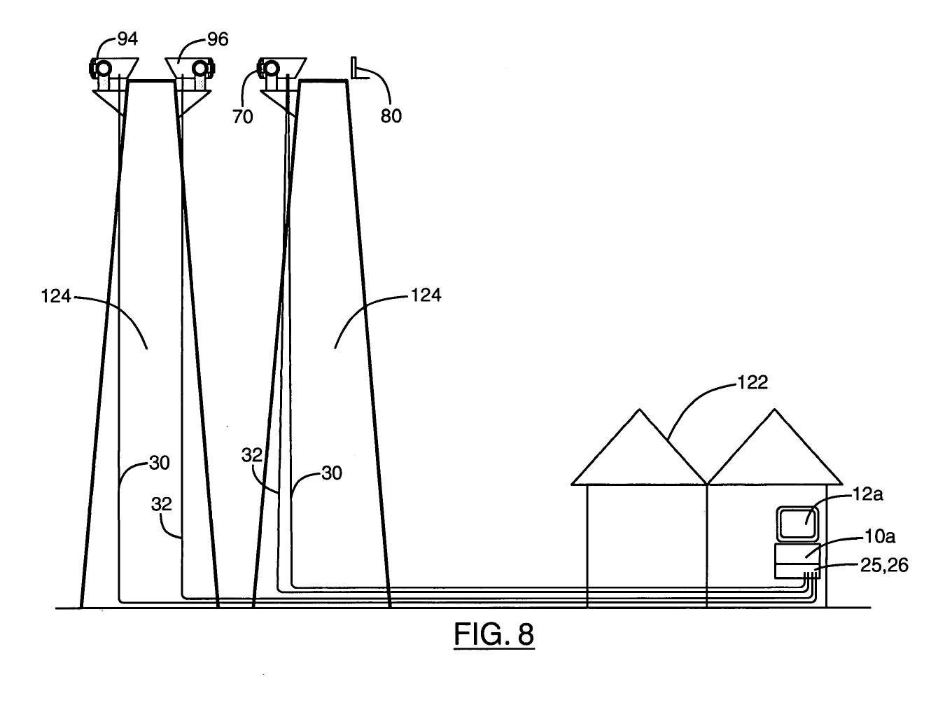

Reference will now be made to FIG. 8, which shows an implementation of the system of the present invention. This shows a schematic implementation of a factory installation, including buildings 122, housing offices, administrative and control equipment. It also includes a number of stacks for flue or other process gases, of which two are indicated at 124.

The system with the fiber optic network configuration of FIG. 3a and/or 3b is installed in this case, but for simplicity the description is in relation to the first embodiment of FIG. 3a. The system control and acquisition computer 12a and the laser controller 10a are located in one of the buildings 122. These would then be connected to the fiber optic multiplexers 25 and 26 by the single and multiple mode optical fibers (not shown in FIG. 8), or just single mode fibers and a single multiplexer 225 in the second embodiment.

The optical multiplexers 25, 26 or 225 are then in turn connected to the single and multiple mode optical fibers 30, 32 or 230.

Here, one stack 124 is equipped with the remote sensing configuration 14a or 214. As shown, the telescope 70 is mounted on one side of the stack and the reflector 80 is mounted on the other. One pair of optical cables 30, 32 is connected to the telescope 70, or single fiber 230 in the case of the configuration 214.

For the other stack 124, by way of example, there is shown the remote sensing configuration 14b of FIG. 1a. This includes a transmitting telescope 94 on one side and a receiving telescope 96 on the other side. Again, a pair of optical fibers 30, 32 is provided.

This arrangement enables the sensitive equipment, e.g. the laser and the detector, to be located in the buildings 122, where repair and maintenance are readily provided. Further, these instruments are not then located in the hostile environment at the top of the stacks 124. The gases emitted from the stacks 126 can include many chemicals that are corrosive etc., which could damage the equipment. Here, at worst, such damage will be incurred by the relatively simple and inexpensive remote sensing equipment, which can be replaced if necessary.

1. An apparatus for monitoring selected trace constituent gases in the atmosphere, the apparatus comprising:
(a) a laser tuneable over a range of frequencies for generating a laser beam;
(b) control means to control the frequency of the laser to scan across an absorption range encompassing an absorption line of a selected trace constituent gas of interest;
(c) transmission means to transmit the laser beam through a region of the atmosphere;
(d) detection means for detecting the laser beam after transmission through the region of the atmosphere; and
(e) processing means for providing the concentration of the selected constituents by comparing the detected laser beam to the transmitted laser beam.

2. An apparatus as claimed in claim 1 wherein the control means comprises a generator means to control the frequency of the laser to rapidly scan across the absorption range of interest.

3. An apparatus as claimed in claim 2 wherein the generator is a ramp generator.

4. An apparatus as claimed in claim 3 wherein the ramp generator has a frequency in the range of 10-100 kHz.

5. An apparatus as claimed in claim 1 wherein the control means comprises a mixer to create a frequency modulated laser beam.

6. Apparatus according to claim 1 further comprising an optical fiber connection means providing a connection between the laser and the transmission means and providing a connection between the detection means and the processing means.

7. An apparatus as claimed in claim 6 wherein the optical fiber connection means comprises an optical fiber connecting the laser to the transmission means, and connecting the detection means to the processing means for transmission of a returned beam.

8. An apparatus as claimed in claim 7 wherein the optical fiber is a single mode fiber.

9. An apparatus as claimed in claim 8 further comprising a beam splitter and combiner means connected between the laser and the optical fiber, the beam splitter and combiner means also being connected to the processing means.

10. An apparatus as claimed in claim 9 further comprising a reference cell connected to the beam splitter and combiner means for receiving part of the radiation from the laser, for reference purposes.

11. An apparatus as claimed in claim 10 comprising a plurality of lasers, and, for each laser, a respective beam splitter and combiner means connected thereto and a reference cell and a detector both connected to the beam splitter and combiner means, and wherein the apparatus includes a first multiplexer means having a plurality of connections on one side, each connected to one of the beam splitters and combiner means, and a connection on the other side to the transmission means and the detection means.

12. An apparatus as claimed in claim 11 further comprising a second multiplexer means having an input connected to the other side of the first multiplexer means, and a plurality of outputs and wherein the apparatus includes a plurality of pairs of transmission means and receiving means, each pair of transmission and receiving means being connected to one output of the second multiplexer means.

13. An apparatus as claimed in claim 6 further comprising at least one of: (a) multiplexer means and a plurality of pairs of transmission means and detection means, the multiplexer means providing a connection between the optical fiber connection means and the pairs of transmission and detection means for selective connection to one pair thereof, and (b) a plurality of lasers and beam splitter and combiner means connecting the lasers to the optical fiber connection means for simultaneous transmission and reception of at least two different laser beams.

14. An apparatus as claimed in claim 6 wherein the optical fiber transmission means comprises a first optical fiber connecting the laser to the optical transmission means, and a second optical fiber transmitting a returned beam from the detection means to the processing means, wherein the apparatus includes a plurality of pairs of optical transmission means and detection means, wherein each of the first and second optical fibers comprises a first portion and a plurality of second portions, wherein the apparatus further includes a first optical multiplexer having an input connected to the first portion of the first optical fiber, the other end of which is connected to the laser, wherein the plurality of second portions of the first optical fiber provide connections between the first multiplexer and the optical transmission means, wherein a second multiplexer has an output connected to the first portion of the second optical fiber, the other end of which is connected to the detection means, and wherein the plurality of second portions of the second optical fiber provide connections between the second multiplexer and the detection means, the first and second multiplexers being operable to connected a selected pair of the transmission means and the receiving means to the laser and the detection means.

15. An apparatus as claimed in claim 12 comprising a plurality of lasers, and beam splitter and combiner means for combining the outputs from the lasers for communication through the first optical fiber and wherein each laser has an associated beam splitter and combiner means to which its output is connected, each of which beam splitter and combiner means has one output providing a connection to the first optical fiber and another output connected to a reference cell.

16. An apparatus as claimed in claim 6 wherein the detection means is separate from the optical transmission means, for mounting on either side of an area through which the trace constituents to be analyzed passes, and wherein the optical fiber connection means comprises a first transmission optical fiber connecting the laser to the optical transmission means, and a second return optical fiber transmitting a returned beam from the detection means to the processing means.

17. An apparatus as claimed in claim 14 wherein the transmission means and the receiving means comprise a point source monitor, including a multipass sample cell, providing an extended analytical path and wherein the optical fiber connection means comprises a first, transmission optical fiber connecting the laser to the optical transmission means, and a second, return optical fiber transmitting a returned beam from the receiving means to the detector means.

18. An apparatus for the remote detection of selected trace constituent gases in the atmosphere, in use with an installation comprising at least one stack for discharging flue gases to the atmosphere and at least one building providing an enclosed area, the apparatus comprising:
(a) a laser tuneable over a range of frequencies for generating a laser beam;
(b) control means to control the frequency of the laser to scan across an absorption range encompassing an absorption line of a selected trace constituent gas of interest;
(c) transmission means to transmit the laser beam through the flue gas;
(d) detection means for detecting the laser beam after transmission through the flue gas;
(e) processing means for providing the concentration of the selected constituents by comparing the detected laser beam to the transmitted laser beam.
(f) a multiplexer means providing a connection between the laser and the transmission means and between the detection means and the processing means; and
(g) an optical fiber connection means providing a connection between a laser and the optical transmission means and between the detection means and the processing means;
wherein the transmission means and the detection means are mounted to one stack adjacent the top thereof, whereby a laser beam is transmitted through the flue gases discharged in the stack, and wherein the laser, the detection means and the multiplexer means are located in the enclosed area of the building, whereby the laser, the detection means and the multiplexer means are protected by the building, the pairs of optical transmission means and detection means are remote from the laser and the detection means and are connected thereto by the optical fiber connection means, and the multiplexer means can selectively connect the laser to any one pair of the optical transmission means and the detector means.

19. An apparatus as claimed in claim 18 comprising a plurality of lasers, and wherein a beam splitter and combiner means is connected to the lasers, wherein each laser has a respective reference cell connected to the beam splitter and combiner means for receiving a portion of the radiation thereof for reference purposes, and wherein a detector is provided for each laser, connected to the beam splitter and combiner means for receiving a portion of the radiation returned back to the detector.

20. A method of monitoring selected trace constituent gases in the atmosphere, the method comprising:
(a) transmitting a laser beam tuneable over a range of frequencies through a region of the atmosphere to be monitored;
(b) controlling the frequency of the laser to scan across an absorption range encompassing an absorption line of a selected trace constituent gas of interest;
(c) detecting the transmitted laser beam after transmission of the beam through the region of the atmosphere; and
(e) determining the concentration of the selected constituents by comparing the detected laser beam to the transmitted laser beam.
